(19) United States
(12) Patent Application Publication
(10) Pub. No.: US 2025/0033803 A1
(43) Pub. Date: Jan. 30, 2025

(54) SATELLITE CONTROL APPARATUS, SATELLITE CONTROL METHOD, AND RECORDING MEDIUM

(71) Applicant: NEC Corporation, Tokyo (JP)

(72) Inventor: Takashi IKEHARA, Tokyo (JP)

(73) Assignee: NEC Corporation, Tokyo (JP)

(21) Appl. No.: 18/782,172

(22) Filed: Jul. 24, 2024

(30) Foreign Application Priority Data
Jul. 28, 2023 (JP) 2023-123794

(51) Int. Cl. B64G 1/24; B64G 1/10; B64G 3/00; H04B 10/118

(52) U.S. Cl. CPC B64G 1/244; B64G 1/1085; B64G 3/00; H04B 10/118

(57) ABSTRACT

A processor included in a satellite control apparatus carries out an obtaining process of obtaining information pertaining to an orbit, a determining process of determining whether each of second satellite apparatuses is capable of being acquired and tracked from a first satellite apparatus by optical communication, a command creating process of creating a command for acquiring and tracking a second satellite apparatus by optical communication, and transmitting process of transmitting the command to the first satellite apparatus.

This application is based upon and claims the benefit of priority from Japanese patent application No. 2023-123794, filed on Jul. 28, 2023, the disclosure of which is incorporated herein in its entirety by reference.

### TECHNICAL FIELD

The present disclosure relates to a satellite control apparatus, a satellite control method, and a recording medium.

### BACKGROUND ART

There is known a business of providing satellite communication over a wide area with use of a satellite constellation including a plurality of satellite apparatuses. In such a business, in order to monitor and control each satellite apparatus constituting a satellite constellation, it is necessary for a satellite control apparatus on the ground to transmit and receive data, such as a command and telemetry, to and from each satellite apparatus via a ground station antenna.

However, as the number of satellite apparatuses included in a satellite constellation increases, a number of ground station antennas are required so that a satellite control apparatus on the ground transmits and receives data to and from each satellite apparatus. However, installation of the ground station antennas requires a lot of time and costs. Therefore, there is known a technique in which a satellite apparatus relays transmission and reception of data between a ground station antenna and another satellite apparatus.

For example, Patent Document 1 discloses a satellite operation apparatus which carries out control so that a satellite directively tracks a relay satellite that relays communication between the satellite and an earth station.

### CITATION LIST

### Patent Literature

### [Patent Literature 1]

Japanese Patent No. 7211651

### SUMMARY OF INVENTION

### Technical Problem

According to the satellite operation apparatus disclosed in Patent Document 1, the earth station can transmit and receive data to and from only a satellite apparatus with which the relay satellite can have communication. Therefore, in a case where the earth station desires to have communication with a desired satellite apparatus, the relay satellite which can have communication with the desired satellite apparatus needs to exist in an area in which the earth station can transmit and receive data. In other words, the satellite operation apparatus disclosed in Patent Document 1 has a problem that a time during which communication with a desired satellite apparatus cannot be carried out is long.

The present disclosure has been made in view of the above problem, and an example object thereof is to provide a technique for shortening a time during which communication with a desired satellite apparatus cannot be carried out.

### Solution to Problem

A satellite control apparatus in accordance with example aspect of the present disclosure includes at least one processor, the at least one processor carrying out: an obtaining process of obtaining information pertaining to an orbit of each of a plurality of satellite apparatuses each of which includes optical communication equipment; and setting any one of the plurality of satellite apparatuses as a first satellite apparatus in order, and then a determining process of determining, on the basis of the information, whether each of a plurality of second satellite apparatuses which are included in the plurality of satellite apparatuses and which are other than the first satellite apparatus is capable of being acquired and tracked from the first satellite apparatus by optical communication, a command creating process of creating a command for acquiring and tracking, by optical communication, a second satellite apparatus which is capable of being acquired and tracked from the first satellite apparatus by optical communication, on the basis of a result of determination made in the determining process, and a transmitting process of transmitting the command first satellite apparatus.

A satellite control method in accordance with an example aspect of the present disclosure includes: (a) obtaining information pertaining to an orbit of each of a plurality of satellite apparatuses each of which includes optical communication equipment; and (b) setting any one of the plurality of satellite apparatuses as a first satellite apparatus in order, and then (c) determining, on the basis of the information, whether each of a plurality of second satellite apparatuses which are included in the plurality of satellite apparatuses and which are other than the first satellite apparatus is capable of being acquired and tracked from the first satellite apparatus by optical communication, (d) creating a command for acquiring and tracking, by optical communication, a second satellite apparatus which is capable of being acquired and tracked from the first satellite apparatus by optical communication, on the basis of a result of determination made in (b), and (e) transmitting the command to the first satellite apparatus, wherein at least one processor included in a satellite control apparatus carries out (a) to (e).

A recording medium in accordance with an example aspect of the present disclosure is a computer-readable non-transitory recording medium in which a program for causing a computer to function as a satellite control apparatus is recorded, the program causing the computer to carry out: an obtaining process of obtaining information pertaining to an orbit of each of a plurality of satellite apparatuses each of which includes optical communication equipment; and setting any one of the plurality of satellite apparatuses as a first satellite apparatus in order, and then a determining process of determining, on the basis of the information, whether each of a plurality of second satellite apparatuses which are included in the plurality of satellite apparatuses and which are other than the first satellite apparatus is capable of being acquired and tracked from the first satellite apparatus by optical communication, a command creating process of creating a command for acquiring and tracking, by optical communication, a second satellite apparatus which is capable of being acquired and tracked from the first satellite apparatus by optical communication, on the basis of a result of determination made in the determining process, and a transmitting process of transmitting the command to the first satellite apparatus.

### Advantageous Effects of Invention

An example aspect of the present disclosure brings about an example effect that it is possible to provide a technique for shortening a time during which communication with a desired satellite apparatus cannot be carried out.

### BRIEF DESCRIPTION OF DRAWINGS

FIG. 1 is a block diagram illustrating a configuration of a satellite control apparatus in accordance with the present disclosure.

FIG. 2 is a flowchart illustrating a flow of a satellite control method in accordance with the present disclosure.

FIG. 3 is a block diagram illustrating a configuration of a satellite control system in accordance with the present disclosure.

FIG. 4 is a drawing illustrating an example of an orbit of each of a plurality of satellite apparatuses in accordance with the present disclosure.

FIG. 5 is a drawing illustrating an example of results of determination in accordance with the present disclosure.

FIG. 6 is a drawing illustrating the graphed example of the results of the determination in accordance with the present disclosure.

FIG. 7 is a drawing illustrating an example of a list in accordance with the present disclosure.

FIG. 8 is a flowchart illustrating a flow of a satellite control method in accordance with the present disclosure.

FIG. 9 is a drawing illustrating an example of a case where a satellite control apparatus in accordance with the present disclosure transmits a command to a satellite apparatus.

FIG. 10 is a drawing illustrating another example of the case where the satellite control apparatus in accordance with the present disclosure transmits the command to the satellite apparatus.

FIG. 11 is a block diagram illustrating a configuration of a computer which functions as the satellite control apparatus in accordance with the present disclosure.

### EXAMPLE EMBODIMENTS

The following will exemplify embodiments of the present invention. Note, however, that the present limited to example embodiments invention is not described below, but may be altered in various ways by a skilled person within the scope of the claims. For example, the present invention can also encompass, in the scope of the present invention, any example embodiment derived by appropriately combining technical means employed in the example embodiments described below. Further, the present invention can also encompass, in the scope of the present invention, any example embodiment derived by appropriately omitting part of technical means employed in the example embodiments described below. Further, the effects mentioned in the example embodiments described below are examples of the effects expected in the example embodiments described below, and are not intended to define an extension of the present invention. That is, the present invention can also encompass, in the scope of the present invention, any example embodiments that do not bring about the effects mentioned in the example embodiments described below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Satellite Control Apparatus 1)

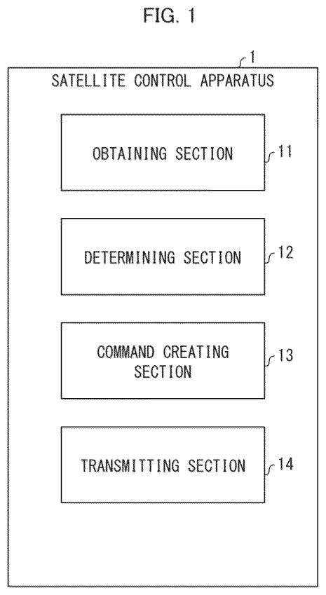

A configuration of a satellite control apparatus 1 is described with reference to FIG. 1. FIG. 1 is a block diagram illustrating the configuration of the satellite control apparatus 1. The satellite control apparatus 1 includes an obtaining section 11, a determining section 12, a command creating section 13, and a transmitting section 14, as illustrated in FIG. 1. The obtaining section 11, the determining section 12, the command creating section 13, and the transmitting section 14 are configurations which realize an obtaining means, a determining means, a command creating means, and a transmitting means, respectively, in the present example embodiment.

The obtaining section 11 obtains information pertaining to an orbit of each of a plurality of satellite apparatuses each of which includes optical communication equipment. The obtaining section 11 supplies the obtained information to the determining section 12.

The determining section 12 sets any one of the plurality of satellite apparatuses as a first satellite apparatus in order. The determining section 12 also determines whether each of a plurality of second satellite apparatuses which are included in the plurality of satellite apparatuses and which are other than the first satellite apparatus is capable of being acquired and tracked from the first satellite apparatus by optical communication, on the basis of the information pertaining to the orbit which information has been obtained by the obtaining section 11. The determining section 12 supplies a result of determination to the command creating section 13.

The command creating section 13 sets any one of the plurality of satellite apparatuses as the first satellite apparatus in order. The command creating section 13 also creates, for the first satellite apparatus, a command for acquiring and tracking, by optical communication, a second satellite apparatus which is capable of being acquired and tracked from the first satellite apparatus by optical communication, on the basis of the result of the determination made by the determining section 12. The command creating section 13 transmits the created command to the transmitting section 14.

The transmitting section 14 sets any one of the plurality of satellite apparatuses as the first satellite apparatus in order. The transmitting section 14 also transmits, to the first satellite apparatus, the command created by the command creating section 13.

### (Effect of Satellite Control Apparatus 1)

As described above, in the satellite control apparatus 1, any one of a plurality of satellite apparatuses is set as a first satellite apparatus in order. The satellite control apparatus 1 employs a configuration such that the satellite control apparatus 1 includes: the obtaining section 11 that obtains information pertaining to an orbit 4 each of the plurality of satellite apparatuses each of which includes optical communication equipment; the determining section 12 that determines whether each of a plurality of second satellite apparatuses which are included in the plurality of satellite apparatuses and which are other than the first satellite apparatus is capable of being acquired and tracked from the first satellite apparatus by optical communication, on the basis of the information pertaining to the orbit which information has been obtained by the obtaining section 11; the command creating section 13 that creates, for the first satellite apparatus, a command for acquiring and tracking, by optical communication, a second satellite apparatus which is capable of being acquired and tracked from the first satellite apparatus by optical communication, on the basis of a result of determination made by the determining section 12; and the transmitting section 14 that transmits, to the first satellite apparatus, the command created by the command creating section 13.

Therefore, the satellite control apparatus 1 brings about an effect that it is possible to shorten a time during which communication with a desired satellite apparatus cannot be carried out.

### (Flow of Satellite Control Method S1)

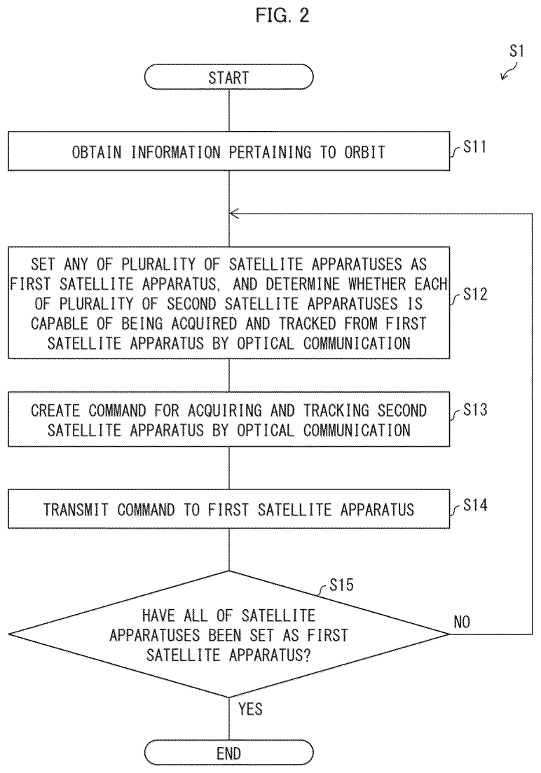

The following description will discuss a flow of a satellite control method S1 with reference to FIG. 2. FIG. 2 is a flowchart illustrating the flow of the satellite control method S1. The satellite control method S1 includes, as illustrated in FIG. 2, an obtaining process S11, a determining process S12, a command creating process S13, and a transmitting process S14.

### (Step S11)

In the step S11, the obtaining section 11 obtains information pertaining to an orbit of each of a plurality of satellite apparatuses each of which includes optical communication equipment. The obtaining section 11 supplies the obtained information to the determining section 12.

The following steps S12 to S14 are carried out until all of the satellite apparatuses are set as the first satellite apparatus. In other words, setting any one of the plurality of satellite apparatuses as the first satellite apparatus and then carrying out the steps S12 to S14 are repeated until all of the satellite apparatuses are set as the first satellite apparatus.

### (Step S12)

In the step S12, the determining section 12 determines whether each of a plurality of second satellite apparatuses which are included in the plurality of satellite apparatuses and which are other than the first satellite apparatus is capable of being acquired and tracked from the first satellite apparatus by optical communication, on the basis of the information pertaining to the orbit which information has been obtained by the obtaining section 11. The determining section 12 supplies a result of determination to the command creating section 13.

### (Step S13)

In the step S13, the command creating section 13 creates, for the first satellite apparatus, a command for acquiring and tracking, by optical communication, a second satellite apparatus which is capable of being acquired and tracked from the first satellite apparatus by optical communication, on the basis of the result of the determination made by the determining section 12. The command creating section 13 transmits the created command to the transmitting section 14.

### (Step S14)

In the step S14, the transmitting section 14 transmits, to the first satellite apparatus, the command created by the command creating section 13.

### (Step S15)

In the step S15, the determining section 12 determines whether all of the satellite apparatuses have been set as the first satellite apparatus.

In a case where it is determined, in the step S15, that all of the satellite apparatuses have not yet been set as the first satellite apparatus (step S15: NO), the processes in the steps S12 to S14 are carried out until each of the plurality of satellite apparatuses is set as the first satellite apparatus.

### (Effect of Satellite Control Method S1)

As described above, the satellite control method S1 employs a configuration such that the satellite control method S1 includes: the step S11 in which the obtaining section 11 obtains information pertaining to an orbit of each of a plurality of satellite apparatuses each of which includes optical communication equipment; setting any one of the plurality of satellite apparatuses as a first satellite apparatus in order; the step S12 in which the determining section 12 determines whether each of a plurality of second satellite apparatuses which are included in the plurality of satellite apparatuses and which are other than the first satellite apparatus is capable of being acquired and tracked from the first satellite apparatus by optical communication, on the basis of the information pertaining to the orbit which information has been obtained by the obtaining section 11; the step S13 in which the command creating section 13 creates, for the first satellite apparatus, a command for acquiring and tracking, by optical communication, a second satellite apparatus which is capable of being acquired and tracked from the first satellite apparatus by optical communication, on the basis of a result of determination made by the determining section 12; and the step S14 in which the transmitting section 14 transmits, to the first satellite apparatus, the command created by the command creating section 13.

Therefore, the satellite control method S1 brings about an effect similar to that brought about by the satellite control apparatus 1.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Outline and Configuration of Satellite Control System 100)

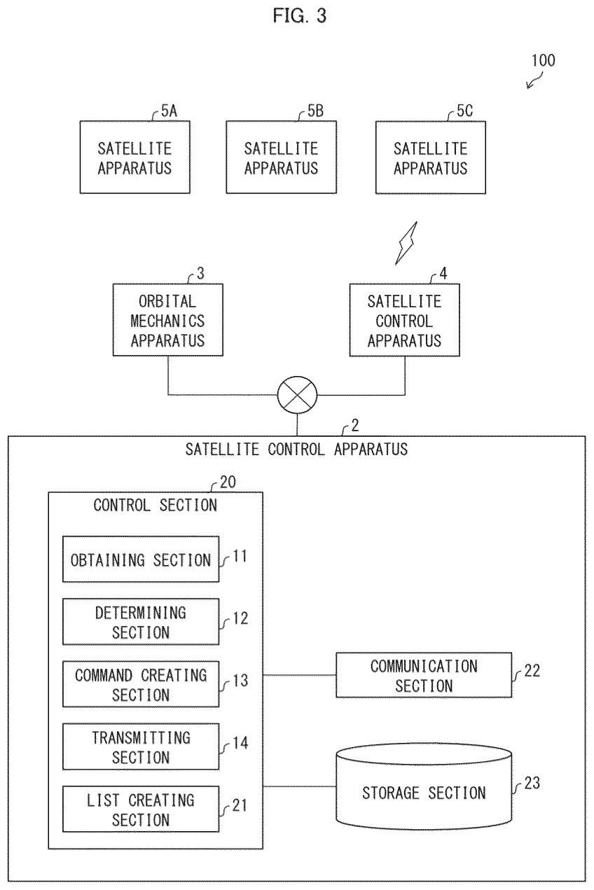

An outline and a configuration of a satellite control system 100 is described with reference to FIG. 3. FIG. 3 is a block diagram illustrating the configuration of the satellite control system 100. The satellite control system 100 includes a satellite control apparatus 2, an orbital mechanics apparatus 3, a satellite control apparatus 4, and a plurality of satellite apparatuses 5 (satellite apparatuses 5A to 5C), as illustrated in FIG. 3. Hereinafter, in a case where it is not particularly necessary to distinguish between the satellite apparatuses 5A to 5C, each of the satellite apparatuses 5A to 5C is simply referred to as “satellite apparatus 5”.

In the satellite control system 100, the satellite apparatus 5 includes optical communication equipment. That is, the satellite apparatus 5 is capable of transmitting data to another satellite apparatus 5 by optical communication, and receiving data from another satellite apparatus 5 by optical communication. Examples of the satellite apparatus 5 include, but are not limited to, low earth orbit (LEO) satellites and middle earth orbit (MEO) satellites. The satellite apparatus 5 is also capable of carrying out optical communication with at least another satellite apparatus 5. As an example, the plurality of satellite apparatuses 5 may form a satellite constellation.

As illustrated in FIG. 3, the satellite control apparatus 4 and the satellite apparatus 5 are capable of transmitting and receiving data to and from each other by wireless communication using radio waves. As an example, the satellite control apparatus 4 transmits a command to the satellite apparatus 5 via a ground station antenna (not illustrated in FIG. 3). As another example, the satellite control apparatus 4 receives telemetry from the satellite apparatus 5 via the ground station antenna.

As illustrated in FIG. 3, the satellite control apparatus 2, the orbital mechanics apparatus 3, and the satellite control apparatus 4 are connected such that the satellite control apparatus 2, the orbital mechanics apparatus 3, and the satellite control apparatus 4 can transmit and receive data to and from each other via a network. Note that each of the orbital mechanics apparatus 3 and the satellite control apparatus 4 may be configured to be included in the satellite control apparatus 2. Note also that each of the satellite control apparatus 2, the orbital mechanics apparatus 3, and the satellite control apparatus 4 may be configured to, for example, output and obtain, off-line via a medium, data stored in each apparatus.

Specific examples of the network include wireless local area networks (LAN), wired LANs, wide area networks (WAN), networks, mobile data communication networks (such as 3G, long term evolution (LTE), 4G, 5G, local 5G), and combinations of these networks. Note, however, that the network is not limited to these examples.

The orbital mechanics apparatus 3 obtains the telemetry received from the satellite apparatus 5, and generates information pertaining to an orbit on the basis of the telemetry. Examples of the information pertaining to the orbit include, but are not limited to, information indicating the orbit of the satellite apparatus 5, information indicating the position of the satellite apparatus 5, and information indicating the velocity of the satellite apparatus 5. The information pertaining to the orbit may be information pertaining to the orbit after elapse of a given time (future orbit).

The satellite control apparatus 2 is an apparatus which generates information for controlling the satellite apparatus 5. As an example, the satellite control apparatus 2 generates the command to be transmitted to the satellite apparatus 5, on the basis of the information pertaining to the orbit of the satellite apparatus 5 which information has been generated by the orbital mechanics apparatus 3. The command is a command for the satellite apparatus 5 to acquire and track, by optical communication, another satellite apparatus 5 which is capable of being acquired and tracked from the satellite apparatus 5 by optical communication.

The command for such optical communication-based acquisition and tracking is a command to control the direction and the amount of light of the optical communication equipment included in the satellite apparatus 5 so that the satellite apparatus 5 carries out optical communication with another satellite apparatus 5.

### (Configuration of Satellite Control Apparatus 2)

The satellite control apparatus 2 includes a control section 20, a communication section 22, and a storage section 23, as illustrated in FIG. 3. The satellite control apparatus 1 may be a single apparatus or may be constituted by a plurality of apparatuses.

The communication section 22 is an interface which transmits and receives data via the network. As an example, the communication section 22 outputs, to the satellite control apparatus 4, data supplied from the control section 20, and obtains data outputted from the orbital mechanics apparatus 3. Examples of the communication section 22 include, but are not limited to, communication chips in various communication standards such as Ethernet (registered trademark), Wi-Fi (registered trademark), and radio communications standards for mobile data communications networks, and universal serial bus (USB)-compliant connectors. In the storage section 23, data referred to by the control section 20 is stored. Examples of the data stored in the storage section 23 include the information pertaining to the orbit, a result of determination described later, a list described later, and the command to be transmitted to the satellite apparatus 5. Examples of the storage section 23 include, but are not limited to, flash memories, hard disk drives (HDDs), solid state drives (SSDs), and combinations of these examples.

### (Function of Control Section 20)

The control section 20 controls each constituent element included in the satellite control apparatus 2.

The control section 20 includes an obtaining section 11, a determining section 12, a command creating section 13, a transmitting section 14, and a list creating section 21, as illustrated in FIG. 3. The obtaining section 11, the determining section 12, the command creating section 13, and the transmitting section 14 are configurations which realize an obtaining means, a determining means, a command creating means, and a transmitting means, respectively, in the present example embodiment.

The obtaining section 11 obtains, from the orbital mechanics apparatus 3, the information pertaining to the orbit of each of the plurality of satellite apparatuses 5. The obtaining section 11 stores the obtained information in the storage section 23.

The determining section 12 sets each of the plurality of satellite apparatuses 5 as a first satellite apparatus, and determines whether each of a plurality of second satellite apparatuses which are other than the first satellite apparatus is capable of being acquired and tracked from the first satellite apparatus by optical communication, on the basis of the information pertaining to the orbit which information is stored in the storage section 23. The determining section 12 stores a result of determination in the storage section 23.

For example, in a case where the determining section 12 sets the satellite apparatus 5A, out of the satellite apparatuses 5A to 5C illustrated in FIG. 3, as the first satellite apparatus, the determining section 12 sets each of the satellite apparatuses 5B and 5C as a second satellite apparatus. In this case, the determining section 12 determines whether each of the satellite apparatuses 5B and 5C is capable of being acquired and tracked from the satellite apparatus 5A by optical communication. Next, the determining section 12 sets the satellite apparatus 5B as the first satellite apparatus, and determines whether each of the satellite apparatuses 5A and 5C is capable of being acquired and tracked from the satellite apparatus 5B by optical communication. Finally, the determining section 12 sets the satellite apparatus 5C as the first satellite apparatus, and determines whether each of the satellite apparatuses 5A and 5B is capable of being acquired and tracked from the satellite apparatus 5C by optical communication. An example of a process carried out by the determining section 12 will be described later.

The list creating section 21 sets each of the plurality of satellite apparatuses 5 as the first satellite apparatus, and creates a list in which the first satellite apparatus is associated with a second satellite apparatus that is capable of being acquired and tracked from the first satellite apparatus by optical communication, on the basis of the result of the determination made by the determining section 12. The list creating section 21 stores the created list in the storage section 23.

For example, on the basis of a result of determination made in a case where the satellite apparatus 5A, out of the satellite apparatuses 5A to 5C illustrated in FIG. 3, is set as the first satellite apparatus, the list creating section 21 associates the satellite apparatus 5A with the satellite apparatus 5 which is capable of being acquired and tracked from the satellite apparatus 5A by optical communication. Next, on the basis of a result of determination made in a case where the satellite apparatus 5B is set as the first satellite apparatus, the list creating section 21 associates the satellite apparatus 5B with the satellite apparatus 5 which is capable of being acquired and tracked from the satellite apparatus 5B by optical communication. Finally, on the basis of a result of determination made in a case where the satellite apparatus 5C is set as the first satellite apparatus, the list creating section 21 associates the satellite apparatus 5C with the satellite apparatus 5 which is capable of being acquired and tracked from the satellite apparatus 5C by optical communication. An example of a process carried out by the list creating section 21 will be described later.

The command creating section 13 sets each of the plurality of satellite apparatuses 5 as the first satellite apparatus, and creates, for the first satellite apparatus, a command for acquiring and tracking, by optical communication, the second satellite apparatus which is capable of being acquired and tracked from the first satellite apparatus by optical communication, on the basis of the list created by the list creating section 21. The command creating section 13 stores the created command in the storage section 23.

For example, on the basis of the list created in a case where the satellite apparatus 5A, out of the satellite apparatuses 5A to 5C illustrated in FIG. 3, is set as the first satellite apparatus, the command creating section 13 creates a command for acquiring and tracking, by optical communication, the satellite apparatus 5 which is capable of being acquired and tracked from the satellite apparatus 5A by optical communication. Next, on the basis of the list created in a case where the satellite apparatus 5B is set as the first satellite apparatus, the command creating section 13 creates a command for acquiring and tracking, by optical communication, the satellite apparatus 5 which is capable of being acquired and tracked from the satellite apparatus 5B by optical communication. Finally, on the basis of the list created in a case where the satellite apparatus 5C is set as the first satellite apparatus, the command creating section 13 creates a command for acquiring and tracking, by optical communication, the satellite apparatus 5 which is capable of being acquired and tracked from the satellite apparatus 5C by optical communication. An example of a process carried out by the command creating section 13 will be described later.

The transmitting section 14 sets each of the plurality of satellite apparatuses 5 as the first satellite apparatus, and transmits, to the first satellite apparatus, the command created by the command creating section 13.

In a case where the transmitting section 14 transmits the command to the first satellite apparatus, the command may be transmitted directly from the satellite control apparatus 4 to the first satellite apparatus or may be transmitted to the first satellite apparatus via another satellite apparatus 5. An example of a process carried out by the transmitting section 14 will be described later.

### Example of Process Carried Out by Determining Section 12

An example of the process carried out by the determining section 12 will be described.

The determining section 12 first calculates a position vector and a velocity vector of each of the first satellite apparatus and the second satellite apparatus, on the basis of the information pertaining to the orbit of each of the first satellite apparatus and the second satellite apparatus. The determining section 12 may calculate the position vector and the velocity vector of each of the first satellite apparatus and the second satellite apparatus, on the basis of the information pertaining to the orbit of each of the first satellite apparatus and the second satellite apparatus after elapse of the given time.

Next, the determining section 12 calculates a relative position vector which is a difference between the calculated position vector of the first satellite apparatus and the calculated position vector of the second satellite apparatus. The determining section 12 also calculates a relative velocity vector which is a difference between the calculated velocity vector of the first satellite apparatus and the calculated velocity vector of the second satellite apparatus. Then, on the basis of the calculated relative position vector and the calculated relative velocity vector, the determining section 12 determines whether the second satellite apparatuses is capable of being acquired and tracked from the first satellite apparatus by optical communication.

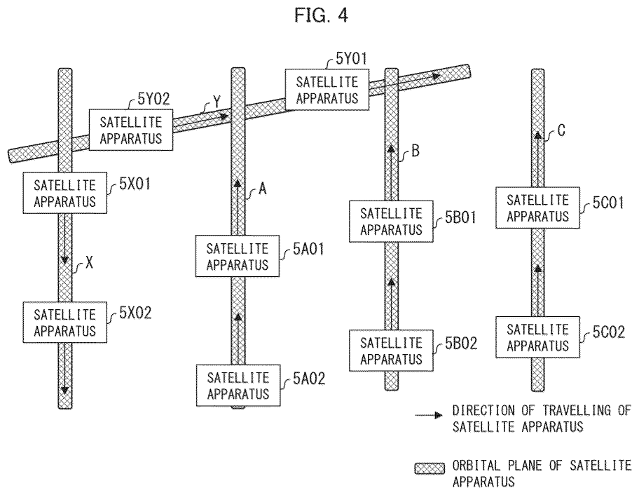

An example of a case where the determining section 12 carries out this process will be described with reference to FIG. 4. FIG. 4 is a drawing illustrating an example of the orbit of each of the plurality of satellite apparatuses 5. The orbit of each of the plurality of satellite apparatuses 5 illustrated in FIG. 4 is a two-dimensional representation of a sub-satellite point trajectory with respect to the ground surface, and the orbital altitude and the orbital plane of an actual orbit have three-dimensional extent.

For example, in FIG. 4, a satellite apparatus 5A01 and a satellite apparatus 5A02 fly upward on an orbital plane A. A satellite apparatus 5B01 and a satellite apparatus 5B02 fly upward on an orbital plane B adjacent to the right side of the orbital plane A. A satellite apparatus 5C01 and a satellite apparatus 5C02 fly upward on an orbital plane C adjacent to the right side of the orbital plane B. A satellite apparatus 5X01 and a satellite apparatus 5X02 fly downward on an orbital plane X adjacent to the left side of the orbital plane A. A satellite apparatus 5Y01 and a satellite apparatus 5Y02 fly rightward on an orbital plane Y which crosses the orbital plane A.

For example, in a case where the determining section 12 sets the satellite apparatus 5A01 as the first satellite apparatus, the determining section 12 sets each of the other satellite apparatuses 5, such as the satellite apparatuses 5A02, 5B01, and 5B02, as the second satellite apparatus. The determining section 12 then calculates a relative position vector and a relative velocity vector with regard to the satellite apparatus 5A01, which is the first satellite apparatus, and each of the other satellite apparatuses 5, each of which is the second satellite apparatus.

Next, the determining section 12 determines whether each of the calculated relative position vector and the calculated relative velocity vector satisfies a constraint condition for the optical communication equipment to carry out optical communication-based acquisition and tracking. The constraint condition is a condition for the second satellite apparatus to be capable of being acquired and tracked from the first satellite apparatus by optical communication.

As an example, in a case where the optical communication equipment included in the satellite apparatus 5 acquires and tracks another satellite apparatus 5 by optical communication, the rotational velocity of the directivity axis, for acquisition and tracking by optical 1 communication, of the optical communication equipment has an upper limit due to power performance. Therefore, it is the constraint condition that a value of the movement velocity of the second satellite apparatus with respect to the first satellite apparatus (i.e., a value of the relative velocity vector) is lower than the upper limit of the rotational velocity of the directivity axis, for acquisition and tracking by optical communication, of the optical communication equipment included in the first satellite apparatus.

As another example, the amount of light, for optical communication, of the optical communication equipment included in the satellite apparatus 5 attenuates in accordance with a distance. Therefore, in a case where a distance from the satellite apparatus 5 to another satellite apparatus 5 with which the satellite apparatus 5 is to carry out communication is excessively long, the satellite apparatus 5 is not capable of acquiring and tracking another satellite apparatus 5 by optical communication. Therefore, it is the constraint condition that a distance between the first satellite apparatus and the second satellite apparatus (i.e., a value of the relative position vector) is shorter than the maximum distance in optical communication of the optical communication equipment included in the first satellite apparatus.

For example, in a case where the satellite apparatus 5A01 in FIG. 4 is set as the first satellite apparatus and the satellite apparatus 5A02, which flies in the same direction as the satellite apparatus 5A01 on the same orbital plane A, is set as the second satellite apparatus, the determining section 12 determines whether each of the calculated relative position vector and the calculated relative velocity vector satisfies the constraint condition.

In a case where each of the calculated relative position vector and the calculated relative velocity vector satisfies the constraint condition for carrying out optical communication-based acquisition and tracking, the determining section 12 determines that the satellite apparatus 5A02 is capable of being acquired and tracked from the satellite apparatus 5A01 by optical communication. On the other hand, in a case where it is determined that at least one of the calculated relative position vector and the calculated relative velocity vector does not satisfy the constraint condition, the determining section 12 determines that the satellite apparatus 5A02 is not capable of being acquired and tracked from the satellite apparatus 5A01 by optical communication.

With this configuration, it is possible for the determining section 12 to suitably determine whether the second satellite apparatus is capable of being acquired and tracked from the first satellite apparatus by optical communication.

In this configuration, the constraint condition may include a condition in which the roundness of the earth is considered. For example, in a case where another satellite apparatus 5 enters the shadow of the earth when the satellite apparatus 5 carries out optical communication with the another satellite apparatus 5, the satellite apparatus 5 is not capable of carrying out optical communication with the another satellite apparatus 5. Therefore, the constraint condition may include a condition that another satellite apparatus 5 does not enter the shadow of the earth, on the basis of the positions of the satellite apparatus 5 and the another satellite apparatus 5 (the value of the relative position vector).

Next, the determining section 12 changes the second satellite apparatus from the satellite apparatus 5A02 to another satellite apparatus 5 (for example, the satellite s 5B01), and similarly determines whether each of the calculated relative position vector and the calculated relative velocity vector satisfies the constraint condition for the optical communication equipment to carry out optical communication-based acquisition and tracking. The determining section 12 repeats this process so as to set all of the satellite apparatuses 5 other than the satellite apparatus 5A01 as the second satellite apparatus and determine whether the second satellite apparatus is capable of being acquired and tracked from the first satellite apparatus by optical communication.

After the determining section 12 sets all of the satellite apparatuses 5 other than the satellite apparatus 5A01 as the second satellite apparatus, the determining section 12 changes the first satellite apparatus to the satellite apparatus 5 other than the satellite apparatus 5A01 (for example, the satellite apparatus 5A02). The determining section 12 then sets all of the satellite apparatuses 5 as the first satellite apparatus and carries out the determining process.

In this manner, the determining section 12 determines whether the second satellite apparatus is capable of being acquired and tracked from the first satellite apparatus by optical communication, on the basis of the calculated relative position vector and the calculated relative velocity vector. Therefore, it is possible for the determining section 12 to suitably determine whether the second satellite apparatus is capable of being acquired and tracked from the first satellite apparatus by optical communication.

### Example of Result of Determination

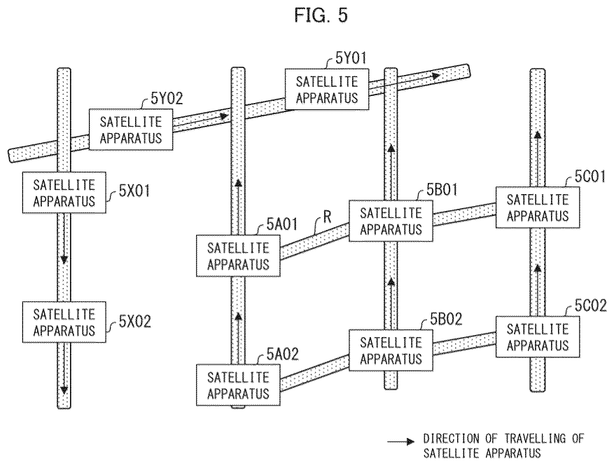

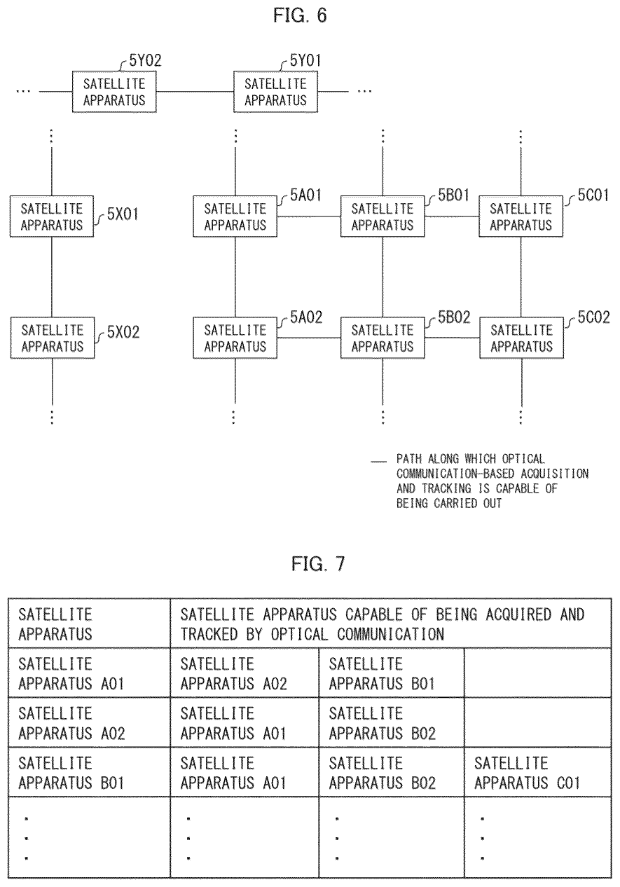

An example of the result of the determination made by the determining section 12 is described with reference to FIGS. 5 and 6. FIG. 5 is a drawing illustrating an example of results of determination. FIG. 6 is a drawing illustrating the graphed example of the results of the determination.

For example, in a case where the first satellite apparatus is the satellite apparatus 5A01 and the second satellite apparatus is the satellite apparatus 5A02, the relative position vector and the relative velocity vector are each small because the satellite apparatuses 5A01 and 5A02 are on the same orbital plane and also fly in the same direction. Therefore, the determining section 12 determines that the satellite apparatus 5A02 is capable of being acquired and tracked from the satellite apparatus 5A01 by optical communication.

In a case where the first satellite apparatus is the satellite apparatus 5A01 and the second satellite apparatus is the satellite apparatus 5B01, the relative position vector and the relative velocity vector are each small because the satellite apparatuses 5A01 and 5B01 are on respective adjacent orbital planes and fly in the same direction. Therefore, the determining section 12 determines that the satellite apparatus 5B01 is capable of being acquired and tracked from the satellite apparatus 5A01 by optical communication.

In a case where the first satellite apparatus is the satellite apparatus 5A01 and the second satellite apparatus is the satellite apparatus 5001, the relative position vector is large because, although the satellite apparatuses 5A01 and 5C01 fly in the same direction, the satellite apparatuses 5A01 and 5C01 are on respective orbital planes which are not adjacent to each other. Therefore, the determining section 12 determines that the satellite apparatus 5001 is not capable of being acquired and tracked from the satellite apparatus 5A01 by optical communication.

In a case where the first satellite apparatus is the satellite apparatus 5A01 and the second satellite apparatus is the satellite apparatus 5X01, the relative velocity vector is large because, although the satellite apparatuses 5A01 and 5X01 are on respective orbital planes which are adjacent to each other, the satellite apparatuses 5A01 and 5X01 fly in respective different directions. Therefore, the determining section 12 determines that the satellite apparatus 5X01 is not capable of being acquired and tracked from the satellite apparatus 5A01 by optical communication.

In a case where the first satellite apparatus is the satellite apparatus 5A01 and the second satellite apparatus is the satellite apparatus 5Y01, each of the relative position vector and the relative velocity vector is large because the satellite apparatuses 5A01 and 5Y01 are on respective orbital planes which are intersect each other and also fly in respective different directions. Therefore, the determining section 12 determines that the satellite apparatus 5Y01 is not capable of being acquired and tracked from the satellite apparatus 5A01 by optical communication.

An example of results of determination made in a case where the determining section 12 thus sets all of the satellite apparatuses 5 as the first satellite apparatus and sets all of the satellite apparatuses 5 as the second satellite apparatus is illustrated in FIG. 5. FIG. 5 illustrates which satellite apparatus is capable of being acquired and tracked from which satellite apparatus by optical communication, with use of a path R along which optical communication-based acquisition and tracking is capable of being carried out.

FIG. 5 illustrates, as an example, that the satellite apparatuses 5 which are capable of being acquired and tracked from the satellite apparatus 5A01 by optical communication are the satellite apparatuses 5A02 and 5B01. As another example, FIG. 5 illustrates that the satellite apparatuses 5 which are capable of being acquired and tracked from the satellite apparatus 5B01 by optical communication are the satellite apparatuses 5A01, 5B02, and 5C01.

In FIG. 5, the satellite apparatus 5 is regarded as a node, and the path R which connects the satellite apparatus 5 and another satellite apparatus 5 is regarded as an edge. In this case, as illustrated in FIG. 6, a graph showing which satellite apparatus is capable of being acquired and tracked from which satellite apparatus by optical communication is created. The graph may be a tree graph which does not have a closed path, or may be a mesh graph which has one or more closed paths. The graph illustrated in FIG. 6 includes a plurality of meshes.

In a case where the path R in FIG. 5 is graphed, a connected graph in which a path that is an edge is present between any two satellite apparatuses may be obtained, or a disconnected graph in which a path that is an edge is not present between any two satellite apparatuses and which includes several graphs may be obtained.

### Example of Process Carried Out by List Creating Section 21

An example of the process carried out by the list creating section 21 will be described.

The list creating section 21 first associates the satellite apparatus 5A01 with the satellite apparatus 5 which is capable of being acquired and tracked from the satellite apparatus 5A01 by optical communication, on the basis of the result of the determination made in a case where the satellite apparatus 5A01 is set as the first satellite apparatus. In a case where the result of the determination is the graph in FIG. 5, the list creating section 21 associates, with the satellite apparatus 5A01, adjacent nodes each connected to the satellite apparatus 5A01 by an edge. In the graph in FIG. 5, the adjacent nodes each connected to the satellite apparatus 5A01 by the edge are the satellite apparatuses 5A02 and 5B01. Therefore, the list creating section 21 creates the list in which the satellite apparatus 5A01 is associated with the satellite apparatuses 5A02 and 5B01.

Next, the list creating section 21 associates the satellite apparatus 5A02 with the satellite apparatus 5 which is capable of being acquired and tracked from the satellite apparatus 5A02 by optical communication, on the basis of the result of the determination made in a case where the satellite apparatus 5A02 is set as the first satellite apparatus. As in the process described above, the list creating section 21 creates the list in which the satellite apparatus 5A02 is associated with the satellite apparatuses 5A01 and 5B02 that are connected to the satellite apparatus 5A02 by edges.

The list creating section 21 carries out a similar process until all of the satellite apparatuses 5 are set as the first satellite apparatus. An example of the list created by the list creating section 21 is illustrated in FIG. 7. FIG. 7 is a drawing illustrating the example of the list.

In FIG. 7, the satellite apparatuses 5A02 and 5B01 are associated with the satellite apparatus 5A01 as the satellite apparatuses 5 which are capable of being acquired and tracked by optical communication. Further, in FIG. 7, the satellite apparatuses 5A01, 5B02, and 5C01 are associated with the satellite apparatus 5B01 as the satellite apparatuses 5 which are capable of being acquired and tracked by optical communication.

### Example of Process Carried Out by Command Creating Section 13

An example of the process carried out by the command creating section 13 will be described.

The command creating section 13 first sets the satellite apparatus 5A01 as the first satellite apparatus and creates a command for the satellite apparatus 5A01. In this case, the command creating section 13 extracts the satellite apparatuses 5A02 and 5B01 each of which is capable of being acquired and tracked from the satellite apparatus 5A01 by optical communication, on the basis of the list created by the list creating section 21. The command creating section 13 then creates a command for the satellite apparatus 5A01 to acquire and track, by optical communication, the satellite apparatuses 5A02 and 5B01.

Next, the command creating section 13 sets the satellite apparatus 5A02 as the first satellite apparatus and creates a command for the satellite apparatus 5A02. Also in this case, as in the process described above, the command creating section 13 creates a command for the satellite apparatus 5A02 to acquire and track, by optical communication, the satellite apparatuses 5A01 and 5B02 each of which is capable of being acquired and tracked from the satellite apparatus 5A02 by optical communication.

The command creating section 13 carries out a similar process until all of the satellite apparatuses 5 are set as the first satellite apparatus. That is, the command creating section 13 creates commands for all of the satellite apparatuses 5.

### Example of Process Carried Out by Transmitting Section 14

An example of the process carried out by the transmitting section 14 will be described.

The transmitting section 14 sets the satellite apparatus 5A01 as the first satellite apparatus, and transmits, to the satellite control apparatus 4, the command created for the satellite apparatus 5A01. In a case where the satellite apparatus 5A01 exists in an area in which the satellite control apparatus 4 is capable of transmitting and receiving data, the satellite control apparatus 4 transmits, to the satellite apparatus 5A01, the command which has been transmitted from the transmitting section 14 and which has been created for the satellite apparatus 5A01.

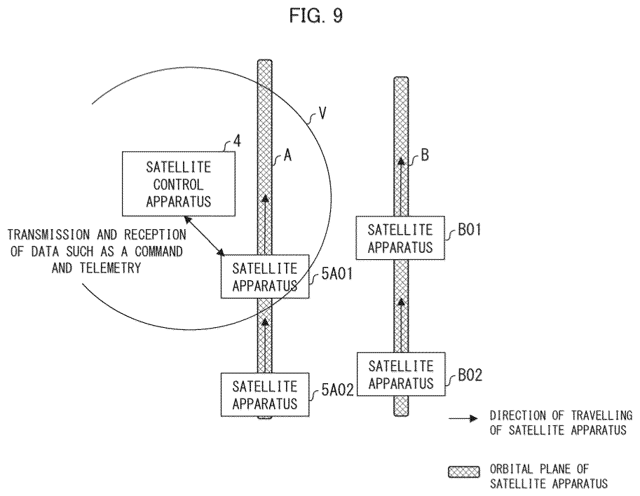

This configuration is described with reference to FIG. 9. FIG. 9 is a drawing illustrating an example of a case where the satellite control apparatus 4 transmits the command to the satellite apparatus 5A01. In FIG. 9, the satellite control apparatus 4 is capable of transmitting and receiving data to and from the satellite apparatus 5 which exists in an area V. The area V varies depending on the altitude of the satellite apparatus 5, and is shown as a circular area in FIG. 9. In FIG. 9, since the satellite apparatus 5A01 exists in the area V, the satellite control apparatus 4 is capable of transmitting and receiving data to and from the satellite apparatus 5A01. In this case, the satellite control apparatus 4 transmits, to the satellite apparatus 5A01, the command which has been outputted from the transmitting section 14 and which has been created for the satellite apparatus 5A01.

In a case where the satellite apparatus 5A01 receives the command transmitted from the satellite control apparatus 4, the satellite apparatus 5A01 carries out a process in accordance with the command. The command includes an instruction to acquire and track the satellite apparatuses 5A02 and 5B01 by optical communication. Therefore, the satellite apparatus 5A01 acquires and tracks the satellite apparatuses 5A02 and 5B01 by optical communication.

### Another Example of Process Carried Out by Transmitting Section 14

Another example of the process carried out by the transmitting section 14 will be described.

The transmitting section 14 sets the satellite apparatus 5A01 as the first satellite apparatus, and transmits, to the satellite control apparatus 4, the command created for satellite apparatus 5A01. In a case where the satellite apparatus 5A01 does not exist in the area in which the satellite control apparatus 4 is capable of transmitting and receiving data, the satellite control apparatus 4 transmits the command to another satellite apparatus 5.

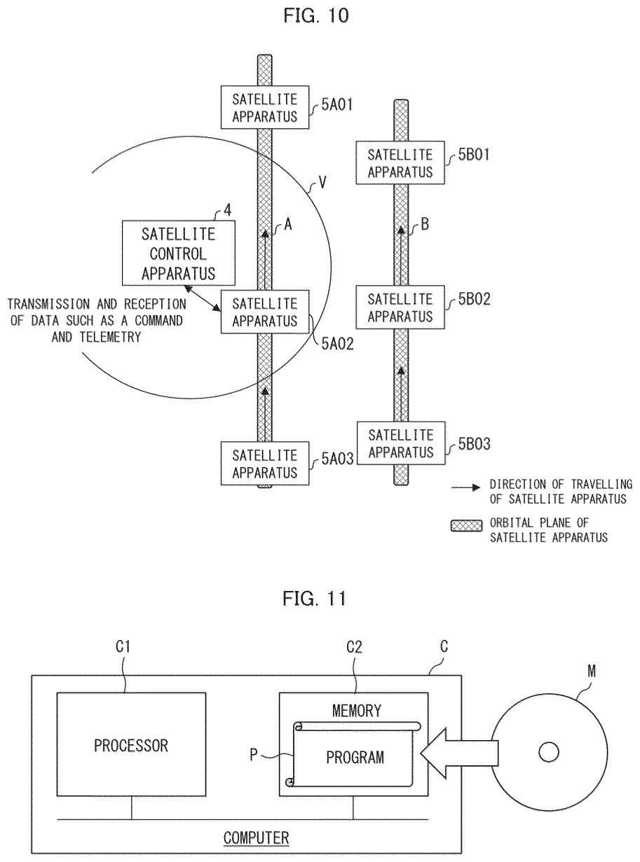

This configuration is described with reference to FIG. 10. FIG. 10 is a drawing illustrating another example of the case where the satellite control apparatus 4 transmits the command to the satellite apparatus 5A01. In FIG. 10, the satellite control apparatus 4 is capable of directly transmitting and receiving data to and from the satellite apparatus 5A02 which exists in the area V. On the other hand, in FIG. 10, the satellite control apparatus 4 is not capable of directly transmitting and receiving data to and from the satellite apparatus 5A01 which does not exist in the area V.

In FIG. 10, the transmitting section 14 first sets the satellite apparatus 5A02 as the first satellite apparatus, and transmits, to the satellite control apparatus 4, the command created for the satellite apparatus 5A02. Since the satellite apparatus 5A02 exists in the area V, the satellite control apparatus 4 transmits, to the satellite apparatus 5A02, the command which has been transmitted from the transmitting section 14 and which has been created for the satellite apparatus 5A02.

In a case where the satellite apparatus 5A02 receives the command transmitted from the satellite control apparatus 4, the satellite apparatus 5A02 acquires and tracks the satellite apparatuses 5A01 and 5B02 by optical communication, in accordance with the command.

Next, the transmitting section 14 sets the satellite apparatus 5A01 as the first satellite apparatus, transmits, to the satellite control apparatus 4, the command which has been created for the satellite apparatus 5A01, together with an instruction to transmit the command to the satellite apparatus 5A01 via the satellite apparatus 5A02. That is, the transmitting section 14 includes, in the command to be transmitted, information indicating a path to the first satellite apparatus. Since the satellite apparatus 5A02 exists in the area V, the satellite control apparatus 4 transmits, to the satellite apparatus 5A02, the command which has been transmitted from the transmitting section 14 and which has been created for the satellite apparatus 5A01.

In a case where the satellite apparatus 5A02 receives the command transmitted from the satellite control apparatus 4, the satellite apparatus 5A02 transmits, to the satellite apparatus 5A01, the command created for the satellite apparatus 5A01, in accordance with the command. In a case where the satellite apparatus 5A01 receives the command transmitted from the satellite apparatus 5A02, the satellite apparatus 5A01 acquires and tracks the satellite apparatuses 5A02 and 5B01 by optical communication, in accordance with the command.

With this configuration, for example, as illustrated in FIG. 10, even in a case where the orbital plane B of the satellite apparatus 5B01 is not included in the area V in which the satellite control apparatus 4 is capable of transmitting and receiving data, the satellite control apparatus 4 is capable of transmitting and receiving data to and from the satellite apparatus 5B01 via the satellite apparatuses 5A02 and 5A01. That is, with this configuration, even in a case where the first satellite apparatus does not exist in the area V in which the satellite control apparatus 4 is capable of directly transmitting and receiving data, the transmitting section 14 is capable of transmitting the command to the first satellite apparatus.

This configuration is realized by the transmitting section 14 referring to the information pertaining to the orbit. For example, it is assumed that the information pertaining to the orbit of the satellite apparatus 5A01 after 5 minutes indicates that the satellite apparatus 5A01 will not exist in the area V after 5 minutes. In this case, in a case where the information pertaining to the orbit of the satellite apparatus 5A02 after 5 minutes indicates that the satellite apparatus 5A02 will exist in the area V after 5 minutes, the transmitting section 14 transmits the command to the satellite apparatus 5A02 after 5 minutes. The transmitting section 14 also transmits, after 5 minutes, the command for the satellite apparatus 5A01 via the satellite apparatus 5A02.

A method for determining a path along which the transmitting section 14 transmits the command to the targeted satellite apparatus 5 includes a method in which a publicly known path search algorithm is used. Examples of the publicly known path search algorithm include shortest path first (SPF). For example, in FIG. 6, in a case where the command is transmitted to the satellite apparatus 5C01 via the satellite apparatus 5A01, the following two paths are considered.

(1) The satellite apparatus 5A01→the satellite apparatus 5B01→the satellite apparatus 5C01

(2) The satellite apparatus 5A01→the satellite apparatus 5A02→the satellite apparatus 5B02→the satellite apparatus 5C02→the satellite apparatus 5C01

In this case, the path (1) has fewer nodes than the path (2). Therefore, the transmitting section 14 transmits, to the satellite apparatus 5001, the command including the information indicating the path (1). The satellite apparatus 5C01 also transmits telemetry to the satellite control apparatus 4 along the same path.

### (Flow of Satellite Control Method S2)

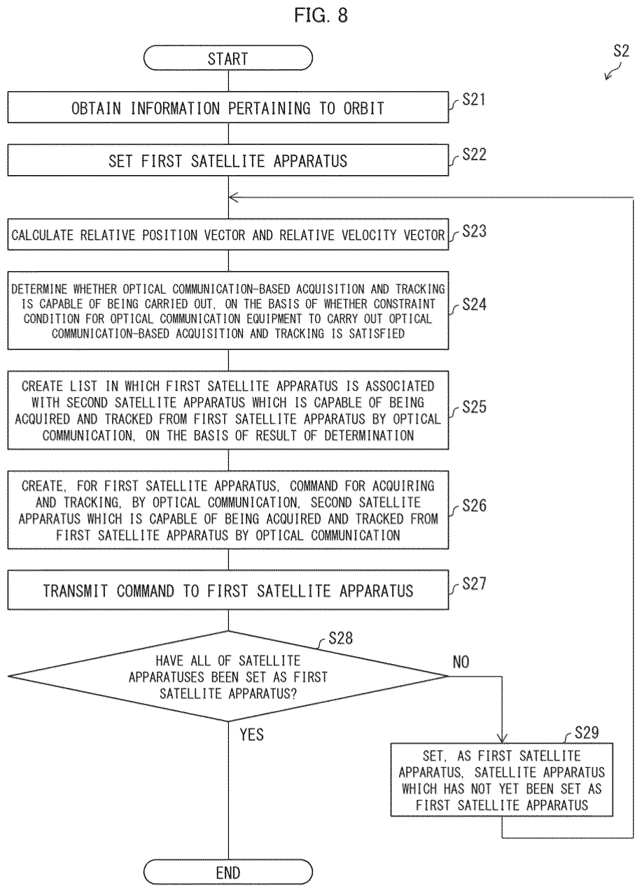

A flow of a satellite control method S2 carried out by the satellite control apparatus 2 is described with reference to FIG. 8. FIG. 8 is a flowchart illustrating the flow of the satellite control method S2.

### (Step S21)

In a step S21, the obtaining section 11 obtains, from the orbital mechanics apparatus 3, information pertaining to the orbit of each of the plurality of satellite apparatuses 5. The obtaining section 11 stores the obtained information in the storage section 23.

### (Step S22)

In a step S22, the determining section 12 sets a first satellite apparatus from the plurality of satellite apparatuses 5.

### (Step S23)

In a step S23, with regard to each of a plurality of second satellite apparatuses other than the set first satellite apparatus, the determining section 12 calculates a relative position vector and a relative velocity vector, on the basis of the information pertaining to the orbit which information is stored in the storage section 23.

### (Step S24)

In a step S24, on the basis of whether each of the relative position vector and the relative velocity vector satisfies the constraint condition for the optical communication equipment to carry out optical communication-based acquisition and tracking, the determining section 12 determines whether each of the second satellite apparatuses is capable of being acquired and tracked from the first satellite apparatus by optical communication. The determining section 12 stores a result of determination in the storage section 23.

### (Step S25)

In a step S25, on the basis of the result of the determination which result is stored in the storage section 23, the list creating section 21 creates a list in which the first satellite apparatus is associated with a second satellite apparatus which is capable of being acquired and tracked from the first satellite apparatus by optical communication. The list creating section 21 stores the created list in the storage section 23.

### (Step S26)

In a step S26, the command creating section 13 creates, for the first satellite apparatus, a command for acquiring and tracking, by optical communication, the second satellite apparatus which is capable of being acquired and tracked from the first satellite apparatus by optical communication, on the basis of the list stored in the storage section 23. The command creating section 13 stores the created command in the storage section 23.

### (Step S27)

In a step S27, the transmitting section 14 transmits, to the first satellite apparatus, the command which is stored in the storage section 23 and which is for the first satellite apparatus.

### (Step S28)

In a step S28, the determining section 12 determines whether all of the satellite apparatuses 5 have been set as the first satellite apparatus.

In a case where it is determined, in the step S28, that all of the satellite apparatuses 5 are set as the first satellite apparatus (step S28: YES), the satellite control apparatus 2 ends the satellite control method S2.

### (Step S29)

In a case where it is determined, in the step S28, that all of the satellite apparatuses 5 have not yet been set as the first satellite apparatus (step S28: NO), in a step S29, the determining section 12 sets, as the first satellite apparatus, the satellite apparatus which has not yet been set as the first satellite apparatus, and returns to the process in the step S23.

That is, the determining section 12 sets each of the plurality of satellite apparatuses 5 as the first satellite apparatus by repeating the process in the step S29.

Further, by repeating the process in the step S23, the determining section 12 calculates the relative position vector and the relative velocity vector with regard to each of the plurality of second satellite apparatuses in a case where each of the plurality of satellite apparatuses 5 is set as the first satellite apparatus, on the basis of the information pertaining to the orbit which information is stored in the storage section 23.

Further, by repeating the process in the step S24, the determining section 12 sets each of the plurality of satellite apparatuses 5 as the first satellite apparatus, and determines whether each of the plurality of second satellite apparatuses is capable of being acquired and tracked from the first satellite apparatus by optical communication.

Further, by repeating the process in the step S25, the list creating section 21 creates the list in which each of the plurality of satellite apparatuses 5 is set as the first satellite apparatus.

Further, by repeating the process in the step S26, the command creating section 13 creates the command in which each of the plurality of satellite apparatuses 5 is set as the first satellite apparatus.

Further, by repeating the process in the step S27, the transmitting section 14 sets each of the plurality of satellite apparatuses 5 as the first satellite apparatus, and transmits the command.

### (Effect of Satellite Control Apparatus 2)

As has been described, the satellite control apparatus 2 in accordance with the present embodiment creates, for each of the plurality of satellite apparatuses 5, the command for acquiring and tracking, by optical communication, another satellite apparatus 5 which is capable of being acquired and tracked from the each of the plurality of satellite apparatuses 5 by optical communication. The satellite control apparatus 2 then transmits, to the each of the plurality of satellite apparatuses 5, the command for the each of the plurality of satellite apparatuses 5.

With this configuration, the satellite control apparatus 2 is capable of causing each of the plurality of satellite apparatuses 5 to acquire and track, by optical communication, another satellite apparatus 5 which is capable of being acquired and tracked by optical communication. That is, the satellite control apparatus 2 is capable of transmitting, via the satellite apparatus 5 to which the command is capable of being transmitted directly from the satellite control apparatus 4, the command for another satellite apparatus 5 which is different from the satellite apparatus 5. In other words, the satellite control apparatus 2 is capable of transmitting the command also to the satellite apparatus 5 to which the command is not capable of being transmitted directly from the satellite control apparatus 4. Therefore, the satellite control apparatus 2 brings about an effect that it is possible to shorten a time during which communication with a desired satellite apparatus cannot be carried out.

Moreover, with this configuration, the satellite control apparatus 2 is capable of controlling the plurality of satellite apparatuses 5 with use of a small number of satellite control apparatuses 4. Therefore, the satellite control apparatus 2 is capable of causing the satellite control apparatus 4 to efficiently control the plurality of satellite apparatuses 5.

### (Modification 1)

In the present modification, described is a configuration in which the satellite control apparatus 2 repeatedly carries out the process illustrated in FIG. 8 in a case where a given condition is satisfied.

Examples of the given condition include a case where there is a change in the information pertaining to the orbit which information is obtained by the obtaining section 11 from the orbital mechanics apparatus 3 and a case where a given time has elapsed.

In a case where the given condition is satisfied, the satellite control apparatus 2 carries out the process illustrated in FIG. 8. Note, here, that, in the step S26, the command creating section 13 may compare the command which has been created and a previous command which is stored in the storage section 23. In a case where there is a difference between the command which has been created and which is for the first satellite apparatus and the previous command which is stored in the storage section 23 and which is for the first satellite apparatus, the command creating section 13 creates a command based on the difference.

As an example, a case is assumed where the command creating section 13 has created, as the command for the satellite apparatus 5A01, a command for acquiring and tracking the satellite apparatus 5A02 by optical communication. Also, a case is assumed where a previous command which is stored in the storage section 23 and which is for the satellite apparatus 5A01 is a command for acquiring and tracking, by optical communication, the satellite apparatuses 5A02 and 5B01.

In this case, the command created by the command creating section 13 does not include the satellite apparatus 5B01, which is included in the previous command. Therefore, there is a difference. Therefore, the command creating section 13 creates, as a command for the satellite apparatus 5A01, a command for deleting the satellite apparatus 5B01 from the satellite apparatuses 5 which are to be acquired and tracked by optical communication.

As another example, a case is assumed where the command creating section 13 has created, as the command for the satellite apparatus 5A01, a command for acquiring and tracking the satellite apparatuses 5A02 and 5B01 by optical communication. Also, a case is assumed where the previous command which is stored in the storage section 23 and which is for the satellite apparatus 5A01 is a command for acquiring and tracking the satellite apparatus 5A02 by optical communication.

In this case, the command created by the command creating section 13 includes the satellite apparatus 5B01, which is not included in the previous command. Therefore, there is a difference. Therefore, the command creating section 13 creates, as a command for the satellite apparatus 5A01, a command for adding the satellite apparatus 5B01 as the satellite apparatus 5 which is to be acquired and tracked by optical communication.

(Effect of Satellite Control Apparatus 2 in Accordance with the Present Modification)

In this manner, in a case where there is a difference between the command which has been created and which is for the first satellite apparatus and the previous command which is stored in the storage section 23 and which is for the first satellite apparatus, the satellite control apparatus 2 in accordance with the present modification creates a command based on the difference.

As has been described, the satellite control apparatus 2 is capable of transmitting, via the satellite apparatus 5 to which the command is capable of being transmitted directly from the satellite control apparatus 4, the command for another satellite apparatus 5 which is different from the satellite apparatus 5. In this configuration, a communication capacity between the satellite control apparatus 4 and the satellite apparatus 5 to which the command is capable of being transmitted directly from the satellite control apparatus 4 is a bottleneck.

However, the satellite control apparatus 2 in accordance with the present modification creates the command based on the difference between the created command and the previous command. Therefore, the satellite control apparatus 2 in accordance with the present modification is capable of reducing the communication capacity between the satellite control apparatus 4 and the satellite apparatus 5 to which the command is capable of being transmitted directly from the satellite control apparatus 4.

### (Modification 2)

In this modification, a configuration in which a plurality of satellite control apparatuses 4 are included in the satellite control system 100 is described.

In a case where the satellite control system 100 includes the plurality of satellite control apparatuses 4, the plurality of satellite control apparatuses 4 may be installed so as to respectively correspond to the orbital planes of the plurality of satellite apparatuses 5. For example, in the orbits illustrated in FIG. 4, a case is assumed where a satellite control apparatus 4A corresponding to the orbital plane A and a satellite control apparatus 4B corresponding to the orbital plane B are included in the satellite control system 100.

In this case, the satellite control apparatus 4A transmits commands to the satellite apparatuses 5A01 and 5A02 which fly on the orbital plane A. The satellite control apparatus 4B transmits commands to the satellite apparatuses 5B01 and 5B02 which fly on the orbital plane B. The satellite apparatus 5A01 which flies on the orbital plane A acquires and tracks, by optical communication, the satellite apparatus 5A02 which flies on the same orbital plane A, and does not acquire and track, by optical communication, the satellite apparatuses 5B01 and 5B02 which fly on the orbital plane B different from the orbital plane A. Similarly, the satellite apparatus 5B01 which flies on the orbital plane B acquires and tracks, by optical communication, the satellite apparatus 5B02 which flies on the same orbital plane B, and does not acquire and track, by optical communication, the satellite apparatuses 5A01 and 5A02 which fly on the orbital plane A different from the orbital plane B.

(Effect of Satellite Control Apparatus 2 in Accordance with the Present Modification)

Thus, the satellite control system 100 in accordance with the present modification includes the plurality of satellite control apparatuses 4 which respectively correspond to the orbital planes of the plurality of satellite apparatuses 5. Therefore, the satellite control apparatus 2 does not need to determine whether the first satellite apparatus which flies on a certain orbital plane is capable of acquiring and tracking, by optical communication, the satellite apparatus 5 which flies on an orbital plane different from the certain orbital plane. Therefore, the satellite control apparatus 2 in accordance with the present modification is capable of reducing a process.

### Software Implementation Example

Some or all of the functions of the satellite control apparatus 1, 2 (hereinafter also referred to as “each apparatus”) may be implemented by hardware such as an integrated circuit (IC chip), or may be implemented by software.

In the latter case, the each apparatus is realized by, for example, a computer that executes instructions of a program that is software realizing the functions. FIG. 11 illustrates an example of such a computer (hereinafter referred to as “computer C”). FIG. 11 is a block diagram illustrating a hardware configuration of a computer C which functions as the each apparatus.

The computer C includes at least one processor C1 and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. The recording medium M can be, for example, a tape, a disk, a card, a semiconductor memory, a programmable logic circuit, or the like. The computer C can obtain the program P via such recording medium M. The program P can be transmitted via a transmission medium. The transmission medium can be, for example, a communications network, a broadcast wave, or the like. The computer C can obtain the program P via such a transmission medium.

### [Additional Remark 1]

The present disclosure includes techniques described in supplementary notes below. Note, however, that the present invention is not limited to the techniques described in the supplementary notes below, but may be altered in various ways by a skilled person within the scope of the claims.

### (Supplementary Note 1)

A satellite control apparatus including: an obtaining means for obtaining information pertaining to an orbit of each of a plurality of satellite apparatuses each of which includes optical communication equipment; a determining means for setting each of the plurality of satellite apparatuses as a first satellite apparatus and determining, on the basis of the information, whether each of a plurality of second satellite apparatuses which are included in the plurality of satellite apparatuses and which are other than the first satellite apparatus is capable of being acquired and tracked from the first satellite apparatus by optical communication; a command creating means for creating a command for acquiring and tracking, by optical communication, a second satellite apparatus which is capable of being acquired and tracked from the satellite first apparatus by optical communication, on the basis of a result of determination made by the determining means; and a transmitting means for transmitting the command to the first satellite apparatus.

### (Supplementary Note 2)

The satellite control apparatus described in Supplementary note 1, wherein the transmitting means includes, in the command, information indicating a path to the first satellite apparatus.

### (Supplementary Note 3)

The satellite control apparatus described in Supplementary note 1 or 2, wherein, in a case where there is a difference between the command which has been created and which is for the first satellite apparatus and a previous command which is for the first satellite apparatus, the command creating means creates a command based on the difference.

### (Supplementary Note 4)

The satellite control apparatus described in any one of Supplementary notes 1 to 3, wherein the determining means calculates, on the basis of the information, a relative position vector which is a difference between a position vector of the first satellite apparatus and a position vector of the each of the plurality of second satellite apparatuses and a relative velocity vector which is a difference between a velocity vector of the first satellite apparatus and a velocity vector of the each of the plurality of second satellite apparatuses, and determines, on the basis of the relative position vector and the relative velocity vector, whether the each of the plurality of second satellite apparatuses is capable of being acquired and tracked from the first satellite apparatus by optical communication.

### (Supplementary Note 5)

The satellite control apparatus described in Supplementary note 4, wherein, in a case where each of the relative position vector and the relative velocity vector satisfies a constraint condition for carrying out optical communication-based acquisition and tracking, the determining means determines that the each of the plurality of second satellite apparatuses is capable of being acquired and tracked from the first satellite apparatus by optical communication.

### (Supplementary Note 6)

A satellite control method including: (a) obtaining information pertaining to an orbit of each of a plurality of satellite apparatuses each of which includes optical communication equipment; (b) setting each of the plurality of satellite apparatuses as a first satellite apparatus and determining, on the basis of the information, whether each of a plurality of second satellite apparatuses which are included in the plurality of satellite apparatuses and which are other than the first satellite apparatus is capable of being acquired and tracked from the first satellite apparatus by optical communication; (c) creating a command for acquiring and tracking, by optical communication, a second satellite apparatus which is capable of being acquired and tracked from the first satellite apparatus by optical communication, on the basis of a result of determination made in (b); and (d) transmitting the command to the first satellite apparatus, wherein a satellite control apparatus carries out (a) to (d).

### (Supplementary Note 7)

A program for causing a computer to carry out: an obtaining process of obtaining information pertaining to an orbit of each of a plurality of satellite apparatuses each of which includes optical communication equipment; a determining process of setting each of the plurality of satellite apparatuses as a first satellite apparatus and determining, on the basis of the information, whether each of a plurality of second satellite apparatuses which are included in the plurality of satellite apparatuses and which are other than the first satellite apparatus is capable of being acquired and tracked from the first satellite apparatus by optical communication; a command creating process of creating a command for acquiring and tracking, by optical communication, a second satellite apparatus which is capable of being acquired and tracked from the first satellite apparatus by optical communication, on the basis of a result of determination made in the determining process; and a transmitting process of transmitting the command to the first satellite apparatus.

### [Additional Remark 2]

The present disclosure includes techniques described in supplementary notes below. Note, however, that the present invention is not limited to the techniques described in the supplementary notes below, but may be altered in various ways by a skilled person within the scope of the claims.

### (Supplementary Note 1)

A satellite control apparatus including at least one processor, the at least one processor carrying out: an obtaining process of obtaining information pertaining to an orbit of each of a plurality of satellite apparatuses each of which includes optical communication equipment; and setting any one of the plurality of satellite apparatuses as a first satellite apparatus in order, and then a determining process of determining, on the basis of the information, whether each of a plurality of second satellite apparatuses which are included in the plurality of satellite apparatuses and which are other than the first satellite apparatus is capable of being acquired and tracked from the first satellite apparatus by optical communication, a command creating process of creating a command for acquiring and tracking, by optical communication, a second satellite apparatus which is capable of being acquired and tracked from the first satellite apparatus by optical communication, on the basis of a result of determination made in the determining process, and a transmitting process of transmitting the command to the first satellite apparatus.

Note that the satellite control apparatus may further include a memory. In the memory, a program for causing the at least one processor to carry out each process may be stored.

### (Supplementary Note 2)

The satellite control apparatus described in Supplementary note 1, wherein, in the transmitting process, the at least one processor includes, in the command, information indicating a path to the first satellite apparatus.

### (Supplementary Note 3)

The satellite control apparatus described in Supplementary note 1 or 2, wherein, in the command creating process, in a case where there is a difference between the command which has been created and which is for the first satellite apparatus and a previous command which is for the first satellite apparatus, the at least one processor creates a command based on the difference.

### (Supplementary Note 4)

The satellite control apparatus described in any one of Supplementary notes 1 to 3, wherein, in the determining process, the at least processor calculates, on the basis of the information, a relative position vector which is a difference between a position vector of the first satellite apparatus and a position vector of the each of the plurality of second satellite apparatuses and a relative velocity vector which is a difference between a velocity vector of the first satellite apparatus and a velocity vector of the each of the plurality of second satellite apparatuses, and determines, on the basis of the relative position vector and the relative velocity vector, whether the each of the plurality of second satellite apparatuses is capable of being acquired and tracked from the first satellite apparatus by optical communication.

### (Supplementary Note 5)

The satellite control apparatus described in Supplementary note 4, wherein, in the determining process, in a case where each of the relative position vector and the relative velocity vector satisfies a constraint condition for carrying out optical communication-based acquisition and tracking, the at least one processor determines that the each of the plurality of second satellite apparatuses is capable of being acquired and tracked from the first satellite apparatus by optical communication.

### REFERENCE SIGNS LIST

1, 2 Satellite control apparatus
3 Orbital mechanics apparatus
4 Satellite control apparatus
5 Satellite apparatus
11 Obtaining section
12 Determining section
13 Command creating section
14 Transmitting section
20 Control section
21 list creating section
22 Communication section
23 Storage section
100 Satellite control system

1. A satellite control apparatus comprising
at least one processor, the at least one processor carrying out:
an obtaining process of obtaining information pertaining to an orbit of each of a plurality of satellite apparatuses each of which includes optical communication equipment; and
setting any one of the plurality of satellite apparatuses as a first satellite apparatus in order, and then
a determining process of determining, on the basis of the information, whether each of a plurality of second satellite apparatuses which are included in the plurality of satellite apparatuses and which are other than the first satellite apparatus is capable of being acquired and tracked from the first satellite apparatus by optical communication,
a command creating process of creating a command for acquiring and tracking, by optical communication, a second satellite apparatus which is capable of being acquired and tracked from the first satellite apparatus by optical communication, on the basis of a result of determination made in the determining process, and
a transmitting process of transmitting the command to the first satellite apparatus.

2. The satellite control apparatus as set forth in claim 1, wherein, in the transmitting process, the at least one processor includes, in the command, information indicating a path to the first satellite apparatus.

3. The satellite control apparatus as set forth in claim 1, wherein, in the command creating process, in a case where there is a difference between the command which has been created and which is for the first satellite apparatus and a previous command which is for the first satellite apparatus, the at least one processor creates a command based on the difference.

4. The satellite control apparatus as set forth in claim 1, wherein
in the determining process, the at least one processor calculates, on the basis of the information,
a relative position vector which is a difference between a position vector of the first satellite apparatus and a position vector of the each of the plurality of second satellite apparatuses and
a relative velocity vector which is a difference between a velocity vector of the first satellite apparatus and a velocity vector of the each of the plurality of second satellite apparatuses, and
determines, on the basis of the relative position vector and the relative velocity vector, whether the each of the plurality of second satellite apparatuses is capable of being acquired and tracked from the first satellite apparatus by optical communication.

5. The satellite control apparatus as set forth in claim 4, wherein, in the determining process, in a case where each of the relative position vector and the relative velocity vector satisfies a constraint condition for carrying out optical communication-based acquisition and tracking, the at least one processor determines that the each of the plurality of second satellite apparatuses is capable of being acquired and tracked from the first satellite apparatus by optical communication.

6. A satellite control method comprising:
(a) obtaining information pertaining to an orbit of each of a plurality of satellite apparatuses each of which includes optical communication equipment; and
(b) setting any one of the plurality of satellite apparatuses as a first satellite apparatus in order, and then
(c) determining, on the basis of the information, whether each of a plurality of second satellite apparatuses which are included in the plurality of satellite apparatuses and which are other than the first satellite apparatus is capable of being acquired and tracked from the first satellite apparatus by optical communication,
(d) creating a command for acquiring and tracking, by optical communication, a second satellite apparatus which is capable of being acquired and tracked from the first satellite apparatus by optical communication, on the basis of a result of determination made in (b), and
(e) transmitting the command to the first satellite apparatus, wherein
at least one processor included in a satellite control apparatus carries out (a) to (e).

7. A computer-readable non-transitory recording medium in which a program for causing a computer to function as a satellite control apparatus is recorded,
the program causing the computer to carry out:
an obtaining process of obtaining information pertaining to an orbit of each of a plurality of satellite apparatuses each of which includes optical communication equipment; and
setting any one of the plurality of satellite apparatuses as a first satellite apparatus in order, and then
a determining process of determining, on the basis of the information, whether each of a plurality of second satellite apparatuses which are included in the plurality of satellite apparatuses and which are other than the first satellite apparatus is capable of being acquired and tracked from the first satellite apparatus by optical communication,
a command creating process of creating a command for acquiring and tracking, by optical communication, a second satellite apparatus which is capable of being acquired and tracked from the first satellite apparatus by optical communication, on the basis of a result of determination made in the determining process, and
a transmitting process of transmitting the command to the first satellite apparatus.
